(19) United States
(12) Patent Application Publication
(10) Pub. No.: US 2015/0165327 A1
(43) Pub. Date: Jun. 18, 2015

(54) SYSTEM AND METHOD FOR AN INTERACTIVE SHOPPING GAME

(71) Applicant: eBay Inc., San Jose, CA (US)

(72) Inventors: Dennis Chu, Fremont, CA (US); Kevin Carvalho, Sunnyvale, CA (US); Michael J. Barnes, Santa Cruz, CA (US)

(21) Appl. No.: 14/108,873

(22) Filed: Dec. 17, 2013

(51) Int. Cl. A63F 13/79

(52) U.S. Cl. CPC A63F 13/79

(57) ABSTRACT

A method and a system for finding products in an in-store shopping environment using an interactive shopping game is described. In an example, the shopping game is generated based on user input, including a shopping list and user personalization information. For example, the interactive shopping game is presented to a user on a portable electronic device to guide the user to find items in the in-store shopping environment.

### TECHNICAL FIELD

The present application relates generally to the technical field of merchandising and, in one specific example, playing an interactive shopping game in an in-store shopping environment to find products.

### BACKGROUND

Shopping with young children, particularly toddlers and preschoolers can be a challenging experience for both the parents and children. A store full of sight, sounds and attractions may look like a playground to a child and full of distractions. It is not uncommon for young children to misbehave or have melt-downs while shopping, especially, if they are tired, bored or uninterested in shopping. It would be desirable to provide a shopping experience tailored towards the interests of children that is productive, educational, and fun.

### BRIEF DESCRIPTION OF THE DRAWINGS

Some embodiments are illustrated by way of example and not limitation in the figures of the accompanying drawings in which:

FIG. 1 is a block diagram illustrating an example embodiment of an in-store shopping environment receiving web services via a cloud computing environment;

FIG. 2 is a network diagram depicting a network system, according to one embodiment, having a client-server architecture configured for exchanging data over a network;

FIG. 3 is a block diagram illustrating a portable electronic device, according to an example embodiment;

FIG. 4 illustrates an example embodiment of a shopping game system having functional modules;

FIG. 5 illustrates a shopping list displayed on an portable electronic device, according to one embodiment;

FIGS. 6-7 illustrate a parent shopping with a child in an in-store shopping environment that provides portable electronic devices for playing an interactive shopping game, according to one embodiment;

FIG. 8 illustrates two portable electronic devices associating with each other, according to one embodiment;

FIG. 9 illustrates personalization of an interactive shopping game with a user's age, according to one embodiment;

FIG. 10 illustrates a user playing an interactive shopping game that displays a flash card with a shopping item for the user to find, according to one embodiment;

FIG. 11 illustrates a user finding an item on the shopping list, according to one embodiment;

FIG. 12 illustrates a user playing an interactive shopping game on a portable electronic device and providing input that he found a shopping item, according to one embodiment;

FIG. 13 illustrates a user playing an interactive shopping game on a portable electronic device and displaying a reward acknowledgment for finding one or more shopping items, according to one embodiment;

FIG. 14 illustrates a user scanning merchant product information with a portable electronic device, according to one embodiment;

FIG. 15 illustrates a user viewing an instant shopping coupon for the item found by playing the interactive shopping game, according to one embodiment;

FIG. 16 illustrates a parent and child customer checking out at the in-store shopping environment, according to one embodiment;

FIG. 17 illustrates the rewards available to the user, at the time of check-out at the in-store shopping environment, for playing the interactive shopping game;

FIG. 18 is a processing flow chart illustrating an example embodiment of a method for generating and presenting an interactive shopping game to find in-store items on a shopping list;

FIG. 19 is a processing flow chart illustrating an example embodiment of a method for setting up and configuring portable electronic devices to play an interactive shopping game;

FIG. 20 is a processing flow chart illustrating an example embodiment of a method for identifying the location of an portable electronic device with a wireless transmitting device;

FIG. 21 is a processing flow chart illustrating an example embodiment of a method for providing a user playing an interactive shopping game with rewards;

FIG. 22 is a processing flow chart illustrating an example embodiment of a method for providing a user with instant shopping coupons when merchant product information is scanned or photographed; and

FIG. 23 shows a diagrammatic representation of machine in the example form of a computer system within which a set of instructions when executed may cause the machine to perform any one or more of the methodologies discussed herein.

### DETAILED DESCRIPTION

Example methods and systems to find in-store products using an interactive shopping game are described. In the following description, for purposes of explanation, numerous specific details are set forth in order to provide a thorough understanding of example embodiments. It will be evident, however, to one skilled in the art that the present invention may be practiced without these specific details.

An interactive shopping game that allows children and parents to discover and browse products in an in-store environment together is described. The interactive shopping game transforms shopping with an ordinary shopping list into a learning and fun adventure for parents and children. The interactive shopping game can be personalized for a child, based on a number of factors, such as age, gender, mood, interests, etc., to create a customized shopping experience. By playing the interactive shopping game, children and parents, can be encouraged to find the items on the shopping list. The shopping game provides activities and features to help guide children to find items on the shopping list, and rewards children for finding the shopping list items. Furthermore, the interactive shopping game may provide parents with an instant shopping coupon that is redeemable at checkout.

### Example Operating Environment

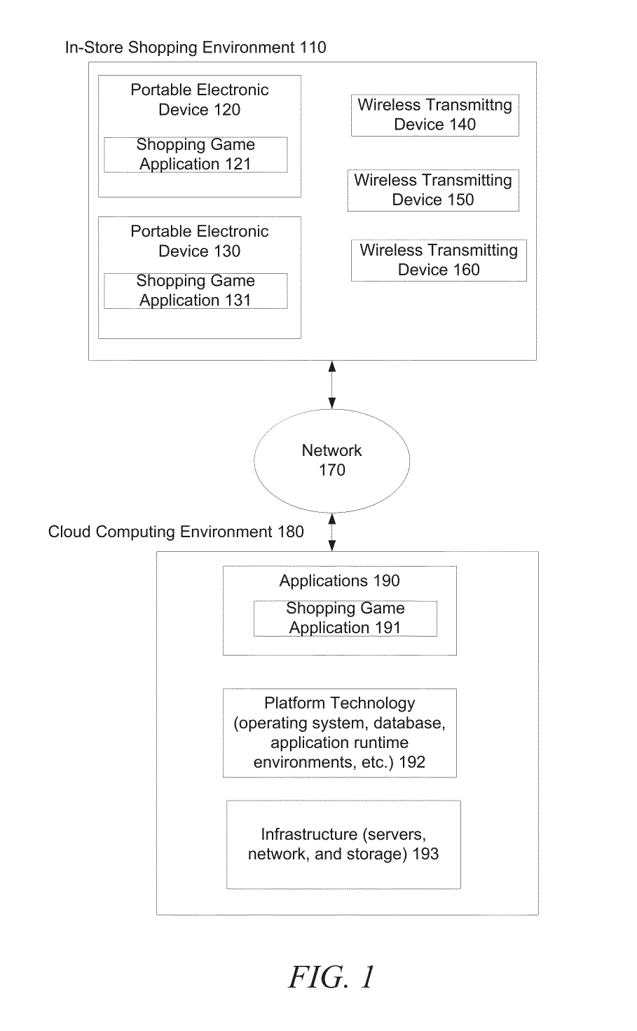

FIG. 1 is a block diagram illustrating an example embodiment of an in-store shopping environment 110 receiving web services from a cloud computing environment 180 via a network 170. The in-store shopping environment 110 includes department stores, general merchandise stores, supermarkets, discount stores or any other type of store or service provider suitable for shopping with children.

The in-store shopping environment 110 includes portable electronic devices 120 and 130, which includes shopping game applications 121 and 131, respectively. The portable electronic devices 120 and 130 are wireless devices that are capable of storing, processing, and transmitting information. The devices include smart phones, personal digital assistants, tablets, smart readers, portable gaming devices, wearable devices, kids' learning tablets and toys, and so forth. By way of example, the portable electronic device may be a smart phone such as a model of an iPhone® available from Apple Inc. of Cupertino, Calif. or a kid's learning tablet such as a LeapPad Ultra available from LeapFrog®. For example, in various embodiments, the shopping game applications 121 and 131 may be an app installed on a smart phone, or alternatively, the shopping game applications 121 and 131 may accessed via a web browser installed on an iPhone®. Although FIG. 1 illustrates two portable electronic devices 120 and 130, one for a child user and one for a parent user, alternative embodiments may be implemented with a single portable electronic device, where the child and parent users share the same portable electronic device. Other embodiments, may use more than two portable electronic devices if more than one child and one parent play the interactive shopping game. For example embodiments, the interactive shopping game is played primarily on the child's portable electronic device by accessing the shopping game application residing on the child's portable electronic device.

The network 170, in one embodiment, may be implemented in a single network or a combination of multiple networks. For example, in various embodiments, the network 170 may include the Internet and/or one or more intranets, landline networks, wireless networks and/or other appropriate types of communication networks. In another example, the network 170 may comprise a wireless telecommunications network (e.g., cellular phone network) adapted to communicate with other communications networks, such as the Internet.

As shown in FIG. 1, system 100 may include one or more wireless transmitting devices 140, 150 and 160 that may be in communication with the portable electronic devices 120 and 130 (provided the devices 120 and 130 are within the appropriate communications range), and the cloud computing environment 180 through the network 170. The portable electronic devices 120 and 130 may be enabled to communicate with the wireless transmitting devices 140, 150 and 160 using short-range connections, such as Bluetooth™ low energy (BLE) or near field communication (NFC), when in the communication zone of wireless transmitting devices 140, 150 and 160.

The wireless transmitting devices 140, 150 and 160 may be installed at one or more locations within an in-store shopping environment 110. These locations may be referred to as check points or game check points within the in-store shopping environment 110. These wireless transmitting devices 140, 150 and 160 may be small sensors placed inside a physical space that transmits data to BLE enabled (or other protocol enabled) portable electronic devices 120 and 130. For various embodiments, the wireless transmitting devices 140, 150 and 160 may discover BLE enabled devices, such as portable electronic devices 120 and 130 once these devices are within the communications range of the wireless transmitting devices 140, 150 and 160. Although FIG. 1 illustrates three wireless transmitting devices, the number of wireless transmitting devices in alternative embodiments may vary.

For various embodiments, the wireless transmitting devices 140, 150 and 160 are beacons. Beacons may take on a variety of form factors and can be placed anywhere in the in-store shopping environment 110. Once the beacons are within a communications range of the portable electronic devices 120 and 130, the beacons can estimate how far away the portable electronic devices 120 and 130 are from it to identify the geo location or proximity of the portable electronic devices 120 and 130 within the in-store shopping environment 110. A beacon may transmit one or more sequences of information to the portable electronic devices 120 or 130 when these devices are within the communications range of the beacon. For example, in addition to providing proximity information, the beacon can provide some content and may instruct the portable electronic devices 120 or 130 to perform an action, such as display a coupon or reward acknowledgement. By way of example, the wireless transmitting devices 140, 150, and 160 may be an iBeacon available from Apple Inc. of Cupertino, Calif. or a PayPal beacon available from eBay Inc. of San Jose, Calif.

For example embodiments, beacons simply advertise data in a peripheral mode by broadcasting a unique identifier. The discovery, handshaking and communications with the beacon may be handled by the portable electronic devices 120 and 130 in example embodiments. This information can be used to understand the location of the portable electronic devices 120 and 130, connect the electronic portable devices 120 and 130 to a service or to content in the cloud computing environment 180. Furthermore, the beacons enable both geofences and true proximity based services (e.g., by touching a portable electronic device against something). As such, the beacons may allow for indoor navigation and maps within the in-store shopping environment 110.

The wireless transmitting devices 140, 150, and 160 may identify the location (or geo location) of the portable electronic devices 120 and 130 within the in-store shopping environment 110; transmit customized coupons to the portable electronic devices 120 and 130; provide walking directions to the aisles or navigation clues where a particular item is located from the portable electronic devices 120 and 130, and prompt a customer with personalized messages using the portable electronic devices 120 and 130. In other words, BLE enabled portable electronic devices 120 and 130 may receive personalized location based notifications and actions while playing the interactive shopping game to alter or change the shopping game experience once the user playing the interactive shopping game on his/her the portable electronic device is within the communications range of one or more check points with wireless transmitting devices 140, 150 and 160.

The cloud computing environment 180, shown in FIG. 1, provides software and hardware resources via the Internet, and delivers applications 190, such as shopping game application 191, running on the cloud infrastructure, to the users of portable electronic devices 120 and 130 over the Internet. The shopping game application 191 may be web-based and delivered on demand as a service (also referred to Software-as-a-service (SaaS)) to the end users of portable electronic devices 120 and 130 over the Internet. The shopping game application 191 may be accessed by the users through the shopping game applications 121 and 131 or web browser, installed on the portable electronic devices 120 and 130. The various functional modules and/or components of the interactive shopping game may be functional modules and/or components of the shopping game application 191 residing on one or more application servers within the cloud computing environment 180 or may be functional modules or components of the shopping game applications 121 and 131 residing on the portable electronic devices 120 and 130 in various embodiments. For an example embodiment, the various modules and/or components may be distributed and/or shared across shopping game application 191 and the shopping game applications 121 and 131.

The applications 190 may support web services application programming interfaces (API) based on standard technologies such as REST, SOAP, or JSON. The content sent over the APIs is usually XML or some form of name/value pairs. The platform technology 192 includes the operating system, database, application runtime environments, etc. in the cloud computing environment 180. The infrastructure 193 includes the compute, network and storage components in the cloud computing environment 180.

### Example Platform Architecture

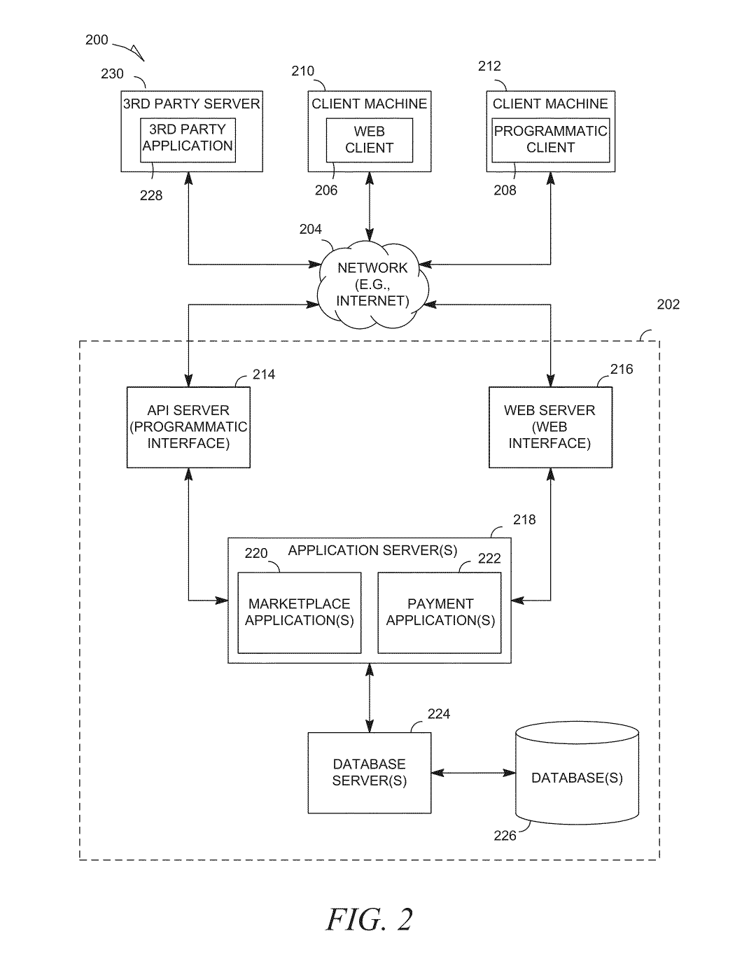

FIG. 2 is a network diagram depicting a client-server system 200, within which one example embodiment may be deployed. A networked system 202, in the example form of a network-based marketplace or publication system, provides server-side functionality, via a network 204 (e.g., the Internet or Wide Area Network (WAN)) to one or more clients. FIG. 2 illustrates, for example, a web client 206 (e.g., a browser, such as the Internet Explorer browser developed by Microsoft Corporation of Redmond, Washington State), and a programmatic client 208 executing on respective client machines 210 and 212. For various embodiments, the client machines 210 and 212 may represent the portable electronic devices 120 and 130, shown in FIG. 1.

An Application Program Interface (API) server 214 and a web server 216 are coupled to, and provide programmatic and web interfaces respectively to, one or more application servers 218. The application servers 218 host one or more marketplace applications 220 and payment applications 222. The application servers 218 are, in turn, shown to be coupled to one or more databases servers 224 that facilitate access to one or more databases 226.

The marketplace applications 220 may provide a number of marketplace functions and services to users that access the networked system 202. For example, the marketplace applications 220 may include the shopping game application 191, shown in FIG. 1. The payment applications 222 may likewise provide a number of payment services and functions to users. The payment applications 222 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 220. While the marketplace and payment applications 220 and 222 are shown in FIG. 2 both form part of the networked system 202, it will be appreciated that, in alternative embodiments, the payment applications 222 may form part of a payment service that is separate and distinct from the networked system 202.

For various embodiments, the marketplace applications 220 may be hosted on dedicated or shared server machines (not shown) that are communicatively coupled to enable communications between server machines. The applications themselves are communicatively coupled (e.g., via appropriate interfaces) to each other and to various data sources, so as to allow information to be passed between the applications or so as to allow the applications to share and access common data. The applications may furthermore access one or more databases 226 via the database servers 224.

The marketplace applications 220 may include personalization applications (not shown) that allow users of the networked system 200 to personalize various aspects of their interactions with the networked system 200. For example, a personalization application may enable a user to personalize the shopping application game 191 and other aspects of their interactions with the networked system 200 and other parties.

The marketplace applications 220 may include one or more imaging applications (not shown) which users may capture and upload images, from the portable electronic devices 120 and 130 for inclusion within shopping game application 191.

The marketplace applications may also include merchandising applications (not shown) to support various merchandising functions that are made available to sellers to enable sellers to increase sales via the networked system 200. The merchandising applications also operate the various merchandising features that may be invoked by sellers, and may monitor and track the success of merchandising strategies employed by sellers. The merchandising applications may also provide customers with various rewards, such as instant shopping coupons, when playing the interactive shopping game.

The marketplace applications may also include a check-in location applications (not shown) for allowing a user of the portable electronic devices 120 and 130 to check in to a location using a check in platform or service such as may be provided by PayPal, Inc. of San Jose, Calif., Foursquare of New York, N.Y., Facebook, Inc., of Menlo Park, Calif., or Google+ of Google, Inc. of Mountain View, Calif., and implemented by remote server 104. In some embodiments, check-in location applications may include multiple application programming interfaces (APIs) for checking in to one or more of the check-in platforms or services. Furthermore, the check-in applications allows a user of the portable electronic devices 120 and 130 to check-in to various locations (for example, game check points) in the in-store shopping environment 110 to provide additional shopping game features, challenges and tasks associated with the location that are accessible once the user has checked-in. For various embodiments, check-in may occur automatically once the portable electronic devices 120 and 130 are within a communications range of one of the wireless transmitting devices 140, 150 and 160.

FIG. 2 also illustrates a third party application 228, executing on a third party server machine 230, as having programmatic access to the networked system 202 via the programmatic interface provided by the API server 214. For example, the third party application 228 may, utilizing information retrieved from the networked system 202, support one or more features or functions on a website hosted by the third party. The third party website may, for example, provide one or more promotional, marketplace or payment functions that are supported by the relevant applications of the networked system 202.

Further, while the system 200 shown in FIG. 2 employs a client-server architecture, the present embodiments is not limited to a client-server architecture, and can be implemented using other architectures such as a distributed, or peer-to-peer, architecture system, for example. The various marketplace and payment applications 220 and 222 may also be implemented as standalone software programs, which do not necessarily have networking capabilities. Alternative embodiments may be implemented in a cloud computing environment 180, as described in FIG. 1, where software is provided as a service to the end users of client machines 210 and 212. The client machines 210 and 212 may access the software applications, such as marketplace applications 210 including the shopping game application 191, through the client machines 210 and 212, while the cloud providers manage the infrastructure and platforms that run the applications.

The web client 206 accesses the various marketplace and payment applications 220 and 222 via the web interface supported by the web server 216. Similarly, the programmatic client 208 accesses the various services and functions provided by the marketplace and payment applications 220 and 222 via the programmatic interface provided by the API server 214. The programmatic client 208 may, for example, be a seller application (e.g., the TurboLister application developed by eBay Inc., of San Jose, Calif.) to enable sellers to author and manage listings on the networked system 202 in an off-line manner, and to perform batch-mode communications between the programmatic client 208 and the networked system 202.

### Example Portable Elctronic Device

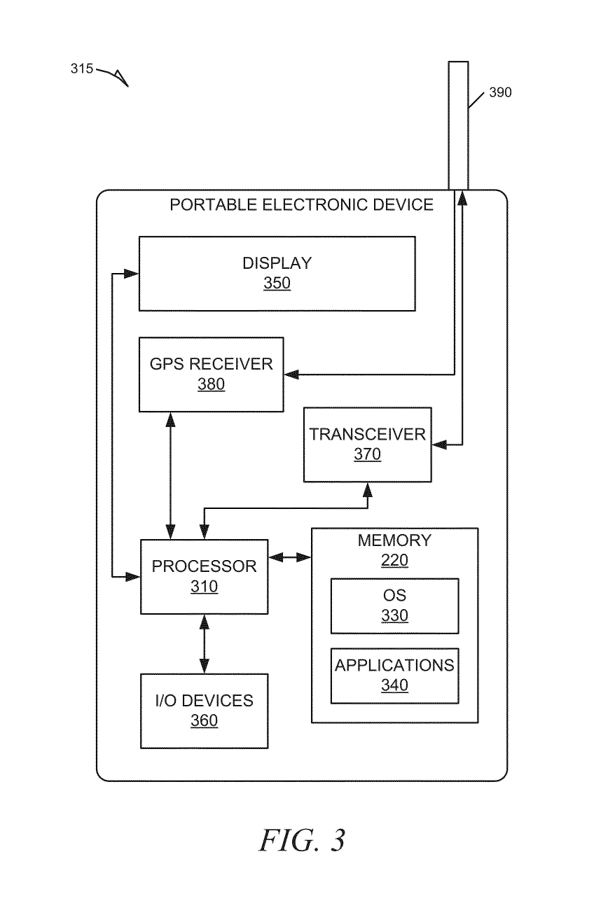

FIG. 3 is a block diagram illustrating a portable electronic device 315, according to an example embodiment. In various embodiments, the portable electronic device 315 is a mobile device, such as a smart phone, which may be BLE enabled or enabled for other short-range connection protocols. The portable electronic device 315 may include a processor 310, which may be any of a variety of different types of commercially available processors suitable for mobile devices (for example, an XScale architecture microprocessor, a Microprocessor without Interlocked Pipeline Stages (MIPS) architecture processor, or another type of processor).

A memory 320, such as a Random Access Memory (RAM), a Flash memory, or other type of memory, is typically accessible to the processor. The memory 320 may be adapted to store an operating system (OS) 330, as well as application programs 340, such as shopping game applications 121 and 131, check-in location applications (not shown), a web browser application (not shown) and other applications that provide additional features, including accessing a user account information. The OS may include a location service (not shown) that watches out (or provides discovery) for wireless transmitting devices (such as wireless transmitting devices 140, 150 and 160, which may be beacons having particular identifiers). Moreover, applications programs 340 may include a check-in location application which can sit in the background, consuming almost no resources or power, until an appropriate wireless transmitting device comes within range of the portable electronic device 315 and wakes the check-in location application up with the news that the portable electronic device 315 is within its range. The wireless transmitting devices can estimate how far away the portable electronic device 315 is from it.

The processor 310 may be coupled, either directly or via appropriate intermediary hardware, to a display 350 and to one or more input/output (I/O) devices 360, such as a keypad, a touch panel sensor, a microphone and the like. Additionally, the portable electronic device 315 may include a camera module (not shown) for acquiring and processing images, such as products and product information in the in-store shopping environment 110 while playing the interactive shopping game. Similarly, in some embodiments, the processor 310 may be coupled to a transceiver 370 that interfaces with an antenna 390. The transceiver 370 may be configured to both transmit and receive cellular network signals, wireless data signals, or other types of signals via the antenna 390, depending on the nature of the portable electronic device 315. In this manner, a connection between portable electronic devices 120 and 130 with network 170 may be established. Further, in some configurations, a GPS receiver 380 may also make use of the antenna 390 to receive GPS signals.

### Example Shopping Game Modules

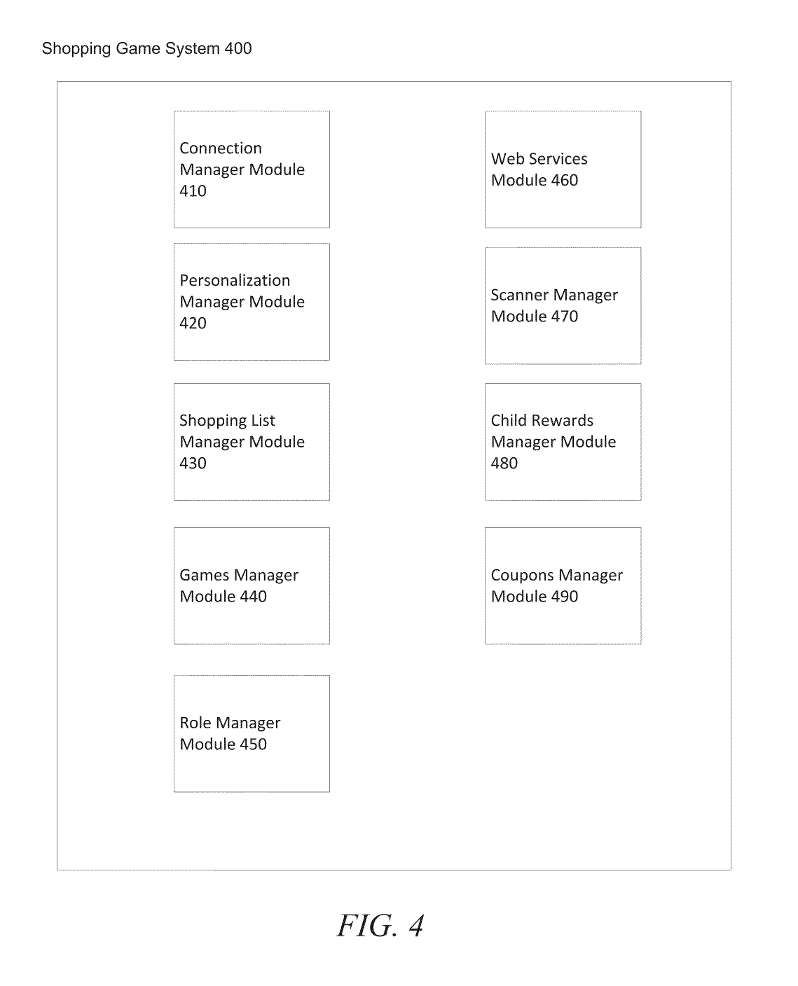

FIG. 4 illustrates an example embodiment of a shopping game system 400 having functional modules. The shopping game system 400 includes the connection manager module 410, the personalization manager module 420, the shopping list manager module 430, the games manager module 440, the role manager module 450, the web services module 460, the scanner manager modules 470, the child rewards manager module 480 and the coupons manager module 490. The various modules shown in the shopping game system 400 may be included, in full or in part, in the shopping game application 191 in the networked system 202, or distributed, in full or in part, across the shopping game applications 121 and 131, or other applications residing on the application server(s) 218 (such as the personalization, merchandising, imaging, check-in location, or other marketplace applications 220). In alternative embodiments, one or more components within each of the functional modules and/or applications residing on the application server(s) 218 described above, may also reside on one of the portable electronic devices 220 and 230.

The shopping game system includes a connection manager module 410 for enabling Wireless Fidelity (Wi-Fi), Bluetooth™ LE and other wireless connections between the various devices within the in-store shopping environment 110, and between the in-store shopping environment 110 and the cloud computing environment 180. For an example embodiment, the connections manager 410 is used to associate a first portable electronic device, referred to as a child's in-store device, with a second portable device, referred to as a parent's smartphone, which includes a shopping list used for the interactive shopping game. When the child's and the parent's portable electronic devices (such as devices 120 and 130) are associated, the shopping game applications 121 and 131 and corresponding data and information may be updated and synchronized on both devices. Although the terms “parent” and “child” are used to describe various embodiments, the term “parent” may be expanded to include other adults or older children who are responsible for watching one or more younger children, and the term “child” may be expanded to include a baby, toddler, child, or an older child or adult having a child-like mentality or exhibits child-like behavior (such as a an older child with a physical and/or mental disability or elderly person).

Furthermore, the connection manager module 410 enables the shopping experience of the child to change dynamically as shopping list items are found and scanned, or when the child's in-store device has its location identified by a wireless transmitting device. Once the wireless transmitting devices such as devices 140, 150 and 160, provides the location (or geo location) information or data of the portable electronic devices of the parent and/or child, the portable electronic devices may receive personalized location based notifications and actions while playing the interactive shopping game. For example, the parent and child, or any other users of the portable electronic devices, may be presented with coupons or reward acknowledgments on their portable electronic device, or receive walking direction or navigation clues through the in-store shopping environment 110 while playing the interactive shopping game.

The web services module 460 in the shopping game system 400 provides communications between the devices in the in-store shopping environment 110, e.g., portable electronic devices 120 and 130, and the cloud computing environment 180. A web service is an application that runs inside a web server, such as web server 116 and is designed to support interoperable machine-to-machine interactions over a network. The web services module provides a standardized way of integrating web-based applications using XML, SOAP, WDSL and UDDI open standards over an Internet protocol backbone. For the example embodiment shown in FIG. 1, the web services module 460 may be used to retrieve the various web-based server applications (for example the marketplace applications, such as the personalization, merchandizing, imaging and check-in location applications) or other web services functions for the networked system 202 according to an example embodiment.

Once the connection is established by the connections manager module 410 between a child's portable electronic device and a parent's portable electronic device (for example, the devices 120 and 130 are associated), the shopping list manager 430 is able to incorporate the shopping list created on the parent's device into the interactive shopping game provided by one or more of the shopping game applications 121, 131 and 191. The shopping list on the parent's device can be created by using a number of available shopping list applications available on the parent's portable electronic device. Additionally, the role manager module 450 establishes which device is the child's device for playing the shopping game and receiving reward acknowledgements, and which device is the parent's device used for providing the shopping list and for receiving the instant shopping coupons.

The personalization manager module 420 allows the users to personalize the shopping game for the child with relevant personal information for creating a customized user shopping experience. For example, the relevant personal information of the child may include the child's age, gender, mood, interests or other criteria which can be used to provide a personalized interactive shopping game. The shopping game may be personalized by providing user input into the child's portable electronic device, the parent's portable electronic device, or other portable electronic device having the shopping game application and synchronized or associated with the child's portable electronic device.

For various embodiments, the child's shopping adventure is influenced by the personalization setting selected by the user. For example, a princess themed user experience may implemented in a shopping game for a 5 year old girl. On the other hand, a dragon or sports themed user experience may be implemented in a shopping game for a 5 year old boy. Furthermore, a flash card themed user experience may be implemented for a 3 year old boy or girl. Additionally, a Wizard of Oz — follow the yellow brick road user experience may be selected for an older child age 8. Other examples of shopping game themes or features that can be used to tailor the user's experience include, but not limited to, scavenger hunts, treasure hunts, hot and cold notifications based on proximity, arcade-like games (e.g., shooting targets, racing, etc.), party-themed games (e.g., pin the tail on the donkey, dressing up, princess, etc.), video games, board games (e.g., candyland, scrabble, monopoly, Where's Waldo, etc.), theme park (Disneyland, etc.), sports (e.g., soccer, football, etc.), TV or movie-themed games, detective/mystery themed games, foreign language-based (Spanish, Chinese, etc.) and educational games (such as flash cards, puzzles, travel, etc.).

The games manager module 12 is responsible for generating and presenting the games based on any personalization settings of a child and the shopping list provided by the parent. The interactive shopping game is presented to the user on the portable electronic devices by accessing an app (such as shopping game applications 121 and 131) or using a web browser, in example embodiments. A number of themed user experiences may be available based on the various personalization settings. For various embodiments, the theme-based interactive shopping game application 191 incorporates product representations of the shopping list items into the shopping game application 191. The game criteria for the various games available from the shopping game application 191 may include, in example embodiments, finding or locating an item on the shopping list within the game, using the pictures in the shopping game to locate the in-store items by following clues, or following navigation clues (e.g., “hot” or “cold”). The items on the shopping list includes products, in example embodiments, but may also be extended to include various services available in the in-store shopping environment 110. The shopping game application 191 presents game features and/or tasks, based on a personalized theme, to guide the child player, in an engaging and fun manner, to locate and find the various products or items on the shopping list.

Further, as the portable electronic devices are identified and discovered when in a communications zone of the wireless transmitting devices, additional game features may be provided to the user to dynamically change the user's experience based on in-store location information. For example, if there are wireless transmission device positioned within the store at various checkpoints, and the portable electronic device is within a communications range of that device, the location of that portable electronic device can be identified. Based on the location information of the portable electronic device, the shopping game system 400 may generates and presents additional game features, challenges, clues or tasks to modify the user's interactive shopping game experience. For example, at a checkpoint, a pop-up target shooting game may be presented to the user, or additional directions or clues down certain aisles within the in-store shopping environment 110 to help guide or navigate the child player to the shopping list items.

As the shopping game is played on the child's portable electronic device, the parent and child browse the product in the store and discover the items on the shopping list. As the shopping list items are found, the child rewards manager module 480 generates and presents rewards and/or reward acknowledgments for the child, to encourage or incentivize the child to continue playing the game and to find the various items on the shopping list. The reward acknowledgements may display images of stickers which can be collected by the child at time of check out. While playing the shopping game, the child may receive reward acknowledgements dynamically as items are found. For alternative embodiments, other incentives may be provided, such as accumulated game points, access to additional game features, personalized messages, etc.

The scanner manager module 470 is an image analysis module, and may use image recognition software and/or hardware to identify product images and product information. As the items on the shopping list are found, the items may be scanned or photographed by one of the portable electronic devices, such as devices 120 and 130. The image captured, by scanning or photographing the product, may include merchant product information, such as the quick response (QR) code, bar code or other label. The users of the portable electronic devices may then be presented with an instant shopping coupon which is redeemable at the time of check out, or other incentive or reward.

Coupon manager module 490 generates and presents instant shopping coupons or other coupons to the users of the portable electronic devices, such as devices 120 and 130, once products on the shopping list are retrieved and scanned by the scanner manager module 470. The coupons or incentives may include product discounts, shipping discounts, or other incentives. For an example embodiment, the shopping coupon is an instant shopping coupon redeemable at check-out when purchasing one or more items on the parent's shopping list.

### Example Shopping Game Application

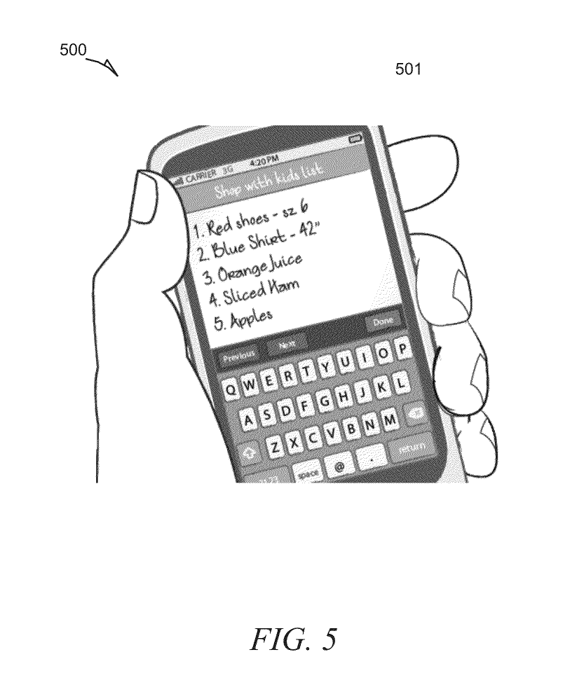

FIG. 5 illustrates a shopping list 501 displayed on a portable electronic device 500, according to one embodiment. The shopping list 501 includes 5 shopping list items: red shoes, blue shirt, orange juice, sliced ham and apples. For an example embodiment, the shopping list was created by a parent on his/her portable electronic device 500. For one embodiment, the shopping list manager module 430 shown in FIG. 4 receives a shopping list 501 created on the parent's portable electronic device. The role manager module 450 shown in FIG. 4 is used to configure the parent's device 500 for playing the interactive shopping game. Configuring the parent's device 500 may include logging into a user account associated with the shopping game application 191.

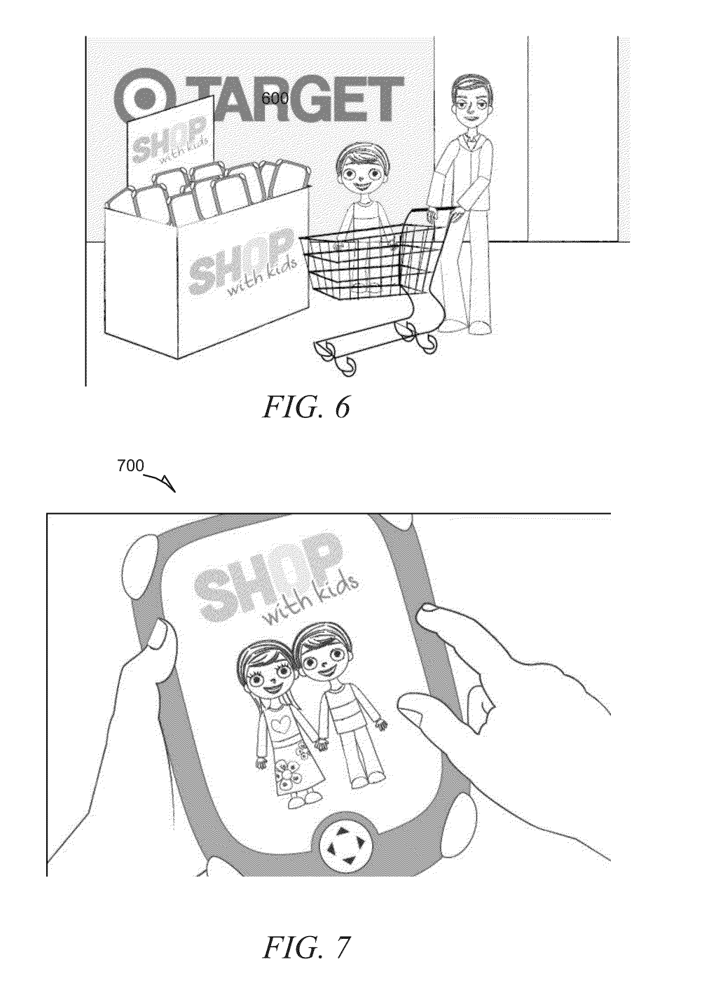

FIGS. 6 and 7 illustrate a parent shopping with his child in an in-store shopping environment 110 that provides portable electronic devices 600 for playing the interactive shopping game, according to one embodiment. The portable electronic device 600 used by the child may be provided by the merchant or provided by the child's parent. In the example shown in FIG. 7, the portable electronic device 700 is provided by the department store Target and is a kid friendly device similar to a kid's learning tablet such as a LeapPad Ultra. The role manager module 450 shown in FIG. 4 is used to configure the child's device 700 for playing the interactive shopping game. Configuring the child's device 700 may include logging into a user account associated with the shopping game application 191.

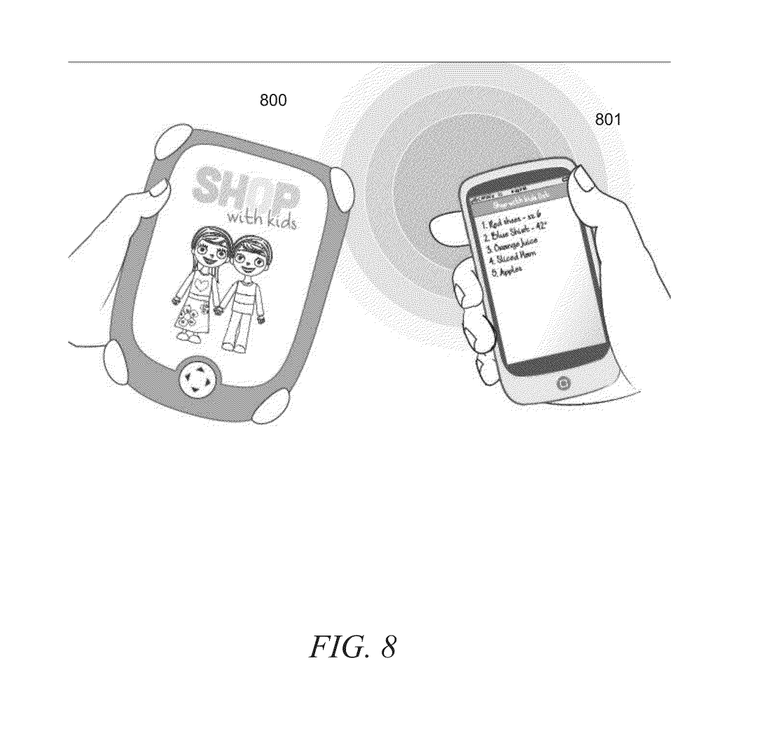

FIG. 8 illustrates two portable electronic devices associating with each other, according to one embodiment. For an example embodiment, the portable electronic device 800 is the child's device and the portable electronic device 801 is the parent's device. The parent and child portable electronic devices 801 and 800, respectively, may be synchronized with each other during the shopping experience, to keep both devices updated as to what each user has found and/or scanned or photographed. For example embodiments, the connection manager module 410 shown in FIG. 4, enables communications between the devices 800 and 801 for associating the devices and providing synchronized data between the devices 800 and 801 while playing the interactive shopping game.

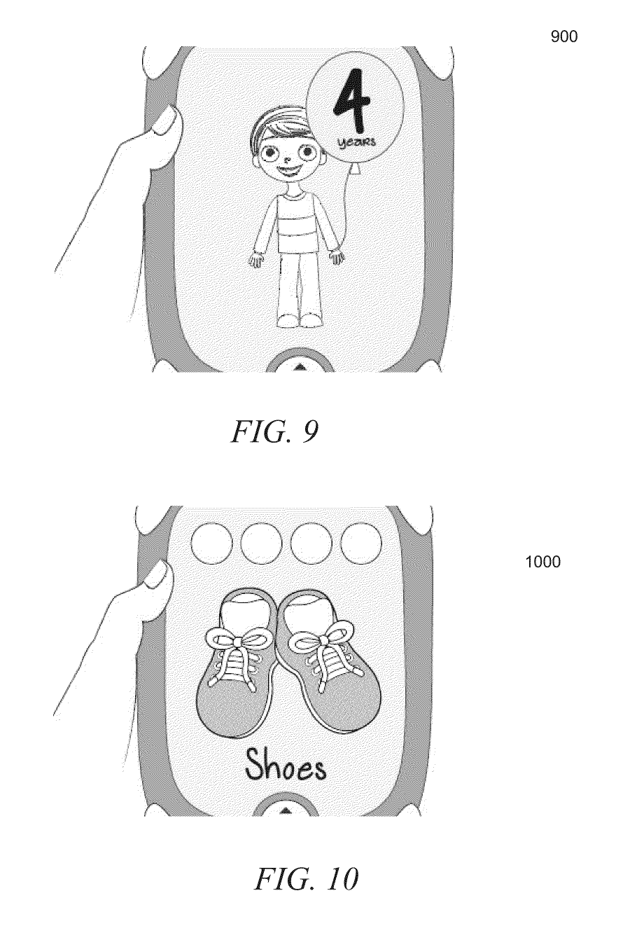

FIG. 9 illustrates an interactive shopping game personalized with a user's age, according to one embodiment. For the embodiment shown in FIG. 9, the interactive shopping game displayed on the portable electronic device 900 is personalized for a 4 year old boy. The portable electronic device 900 receives input from a user to specify the child's age and gender. In alternative embodiments, other personalization information may be used together with the child's age and gender, or separately, to provide a customized user experience while the child is playing the interactive shopping game on the portable electronic device 900. The personalization manager module 420, shown in FIG. 4, is responsible for personalizing the shopping game application 191 based on personal information provided by the user of an associated device. The personal information provided by the user of an associated device, allows the shopping game application 191 to provide an interactive shopping game customized for that particular user based on various criteria, such age, gender, mood, interests, etc.

FIG. 10 illustrates a user playing an interactive shopping game that displays a flash card 1000 with a shopping item for the user to find, according to one embodiment. The flash card 1000 displays an image representing a pair of children's shoes. For this example, the pair of children's shoes is the first item on the shopping list 501. The flash card interactive shopping game is an example of an educational-themed game from the shopping game application 191 that incorporates shopping list items into the game. The game criteria for the flash card interactive shopping game is to find the shopping list items based on the pictures shown on the flash cards 1000. One or more shopping list items are shown in each flash card 1000 displayed on a portable electronic device. Once the item on the flash card 1000 is located and the flash card interactive shopping game is updated with this information, the next flash card is displayed showing a picture of the next item on the shopping list. The game manager module 440 shown in FIG. 4, is responsible for presenting the personalized interactive shopping game for the user to play.

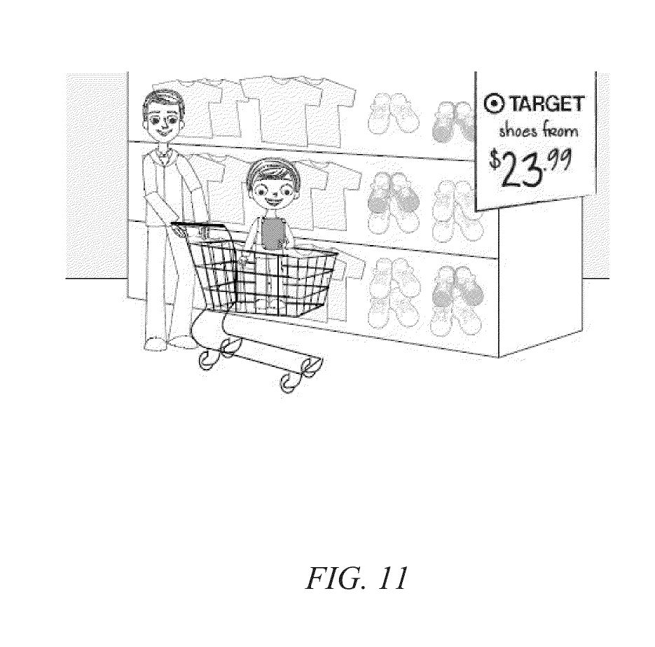

While playing the interactive shopping game, together, the parent and child browse through the store and discover the shopping list items as part of a shopping adventure. FIG. 11 illustrates the parent and child locating the pair of children's shoes, shown on the flashcard 1000, and displayed on the store shelf. The pair of children's shoes 1100 on the shelf was the first item on the shopping list 501 shown in FIG. 5.

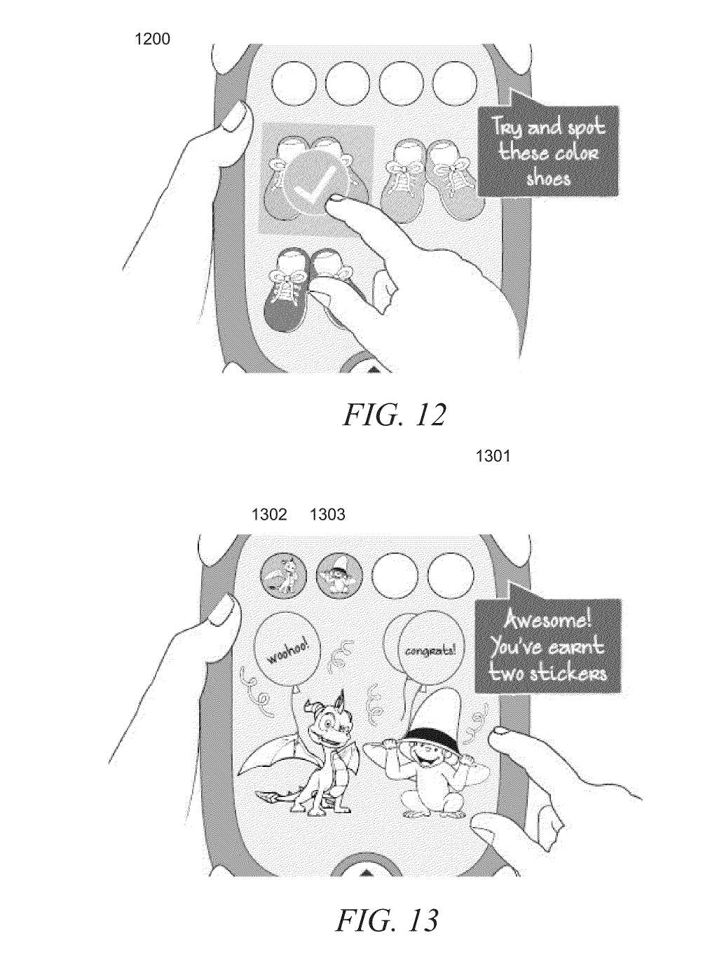

FIG. 12 illustrates a user playing an interactive shopping game on a portable electronic device and providing input that the user found a shopping item, according to one embodiment. The user selects the icon representing the children's red pair of shoes 1200, which corresponds to the pair of red shoes he has found by playing the interactive shopping game and browsing the store. The game manager module 440 shown in FIG. 4, presents the selection screen shown in FIG. 12, to allow the user to provide input to update the shopping game application 191 as shopping items are found. For alternative embodiments, the interactive shopping game, may allow a user to scan an image or the product or product information (e.g., QR code, bar code or label) to provide updates to the shopping game application 191 that a shopping list item has been found. For this alternative embodiment, the scanner module manager 470 shown in FIG. 4, receives the images captured by the portable electronic devices and sent by the user, processes the captured images, and identifies the product associated with the captured images.

FIG. 13 illustrates a user playing an interactive shopping game on a portable electronic device and displaying a reward acknowledgment 1301 for finding one or more shopping items, according to one embodiment. The reward acknowledgment 1301 illustrates that the child has earned a reward of 2 stickers 1302 and 1302. The reward acknowledgement includes several encouraging messages to the child such as “Awesome! You've earned two stickers” and “woohoo!” and “congrats!.” For example embodiments, the reward acknowledgements are generated and provided to the user while playing the interactive shopping game as one or more items are located by the user. The child rewards manager module 480, shown in FIG. 4, is responsible for presenting the reward acknowledgement screen to the user of the portable electronic device. The sticker rewards acknowledged, may be provided to the child upon check out, in example embodiments,

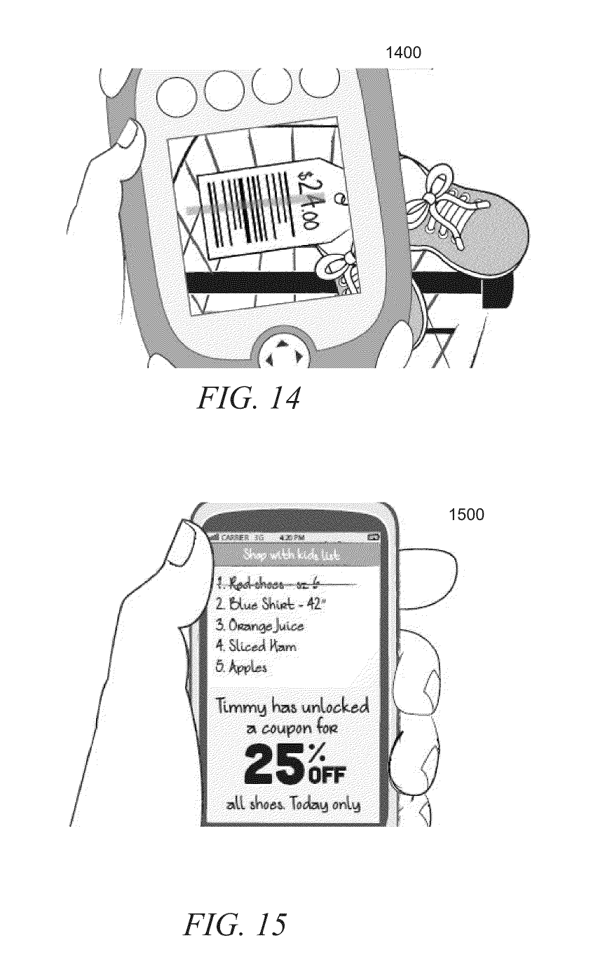

FIG. 14 illustrates a user scanning merchant product information 1400 with a portable electronic device, according to one embodiment. The user is scanning the bar code and product tag for the pair of red shoes found by the child. Once the portable electronic device captures the image of the merchant production information 1400, by scanning or photographing the product tag, by the parent and/or child user of a portable electronic device. The scanner module manager 470 shown in FIG. 4, receives the images captured by the portable electronic devices and sent by the user, processes the captured image, and identifies the product associated with the captured image.

FIG. 15 illustrates a user viewing an instant shopping coupon 1500 for the item found by playing the interactive shopping game, according to one embodiment. The instant shopping coupon 1500 shown on the portable electronic device is for 25% off all shoes purchased redeemable at check out today. For alternative embodiments, the coupon, or other incentive is not required to be redeemed on the same day the items are purchased. The coupons manager module 490 shown in FIG. 4 generates and presents the coupon to the user based on the scanned product information sent by the user and the information provided by the scanner module manager 470, which associates the scanned images with the in-store products.

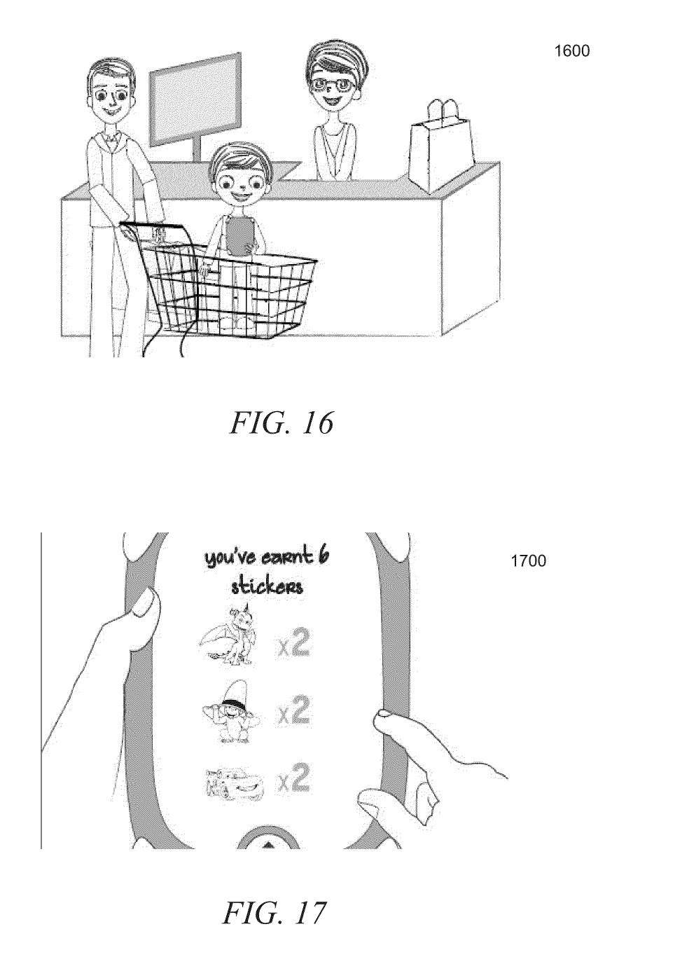

FIG. 16 illustrates a parent and child customer checking out at the in-store shopping environment 1600, according to one embodiment. FIG. 17 illustrates the rewards 1700 available to the user, at the time of check-out at the in-store shopping environment, for playing the interactive shopping game. The rewards shown in FIG. 17 were earned while the child was playing the interactive shopping game and includes 6 stickers that the child can collect at checkout. The rewards may be generated by the child rewards manager module 480 and provided to the child at check out or available at the check-out counter.

### Example Methods

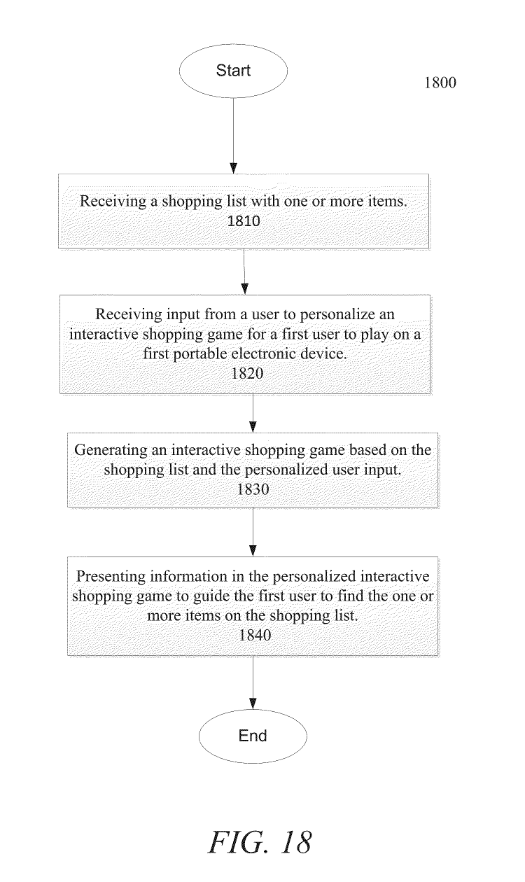

FIG. 18 is a processing flow chart illustrating an example embodiment of a method for generating and presenting an interactive shopping game to find in-store items on a shopping list. In an example, method 1800 includes receiving a shopping list with one or more items at 1810; receiving user input to personalize an interactive shopping game for a first user to play on a first portable electronic device at 1820; generating an interactive shopping game based on the shopping list and the personalized user input at 1830; and presenting information in the interactive shopping game to guide the first user to find the one or more items on the shopping list 1840.

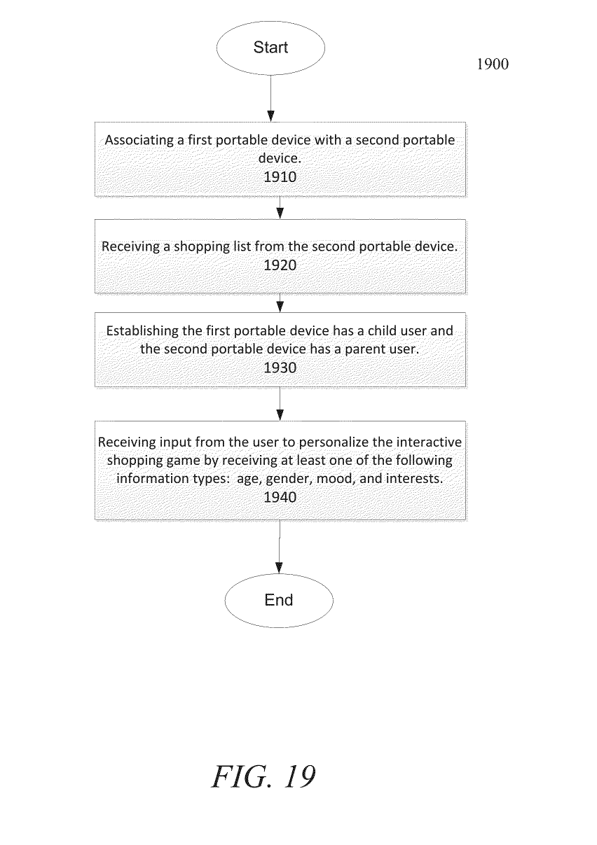

FIG. 19 is a processing flow chart illustrating an example embodiment of a method for setting up and configuring portable electronic devices to play an interactive shopping game. In the example embodiment, the method 1900 includes associating a first portable device with a second portable device at 1910; receiving a shopping list from the second portable device at 1920; establishing the first portable device has a child user and the second portable device has a parent user at 1930; and receiving input from the user to personalize the interactive shopping game by receiving at least one of the flowing information types: ages, gender, mood and interests at 1940.

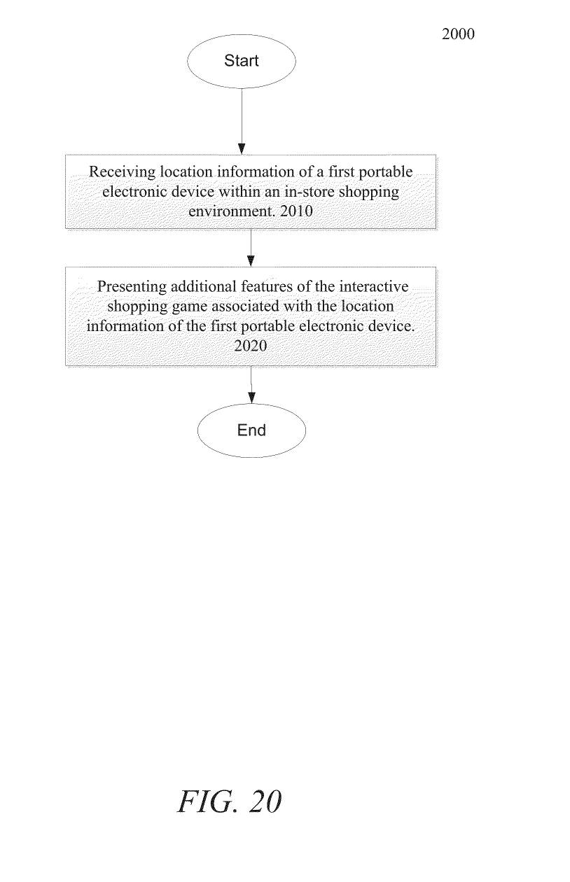

FIG. 20 is a processing flow chart illustrating an example embodiment of a process for identifying the location of a portable electronic device with a wireless transmitting device. In the example embodiment, the method 2000 includes receiving location information of the first portable electronic device at 2010; and presenting additional features of the personalized interactive shopping game associated with the location information of the first portable electronic device at 2020.

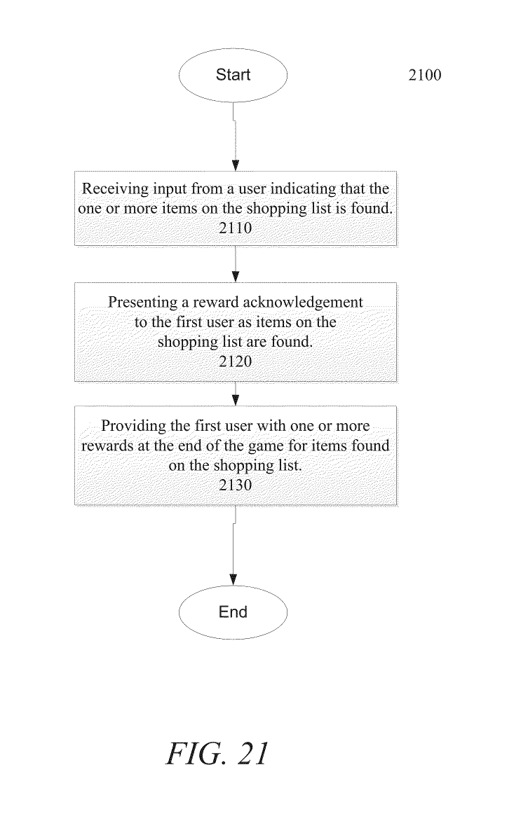

FIG. 21 is a processing flow chart illustrating an example embodiment of a method for providing a user playing an interactive shopping game with rewards. In the example embodiment, the method 2100 includes receiving user input indicating that one or more items on the shopping list is found at 2100, presenting a reward acknowledgement to the first user for the shopping items found at 2020; and providing the first user with a reward for the shopping items found at 2030.

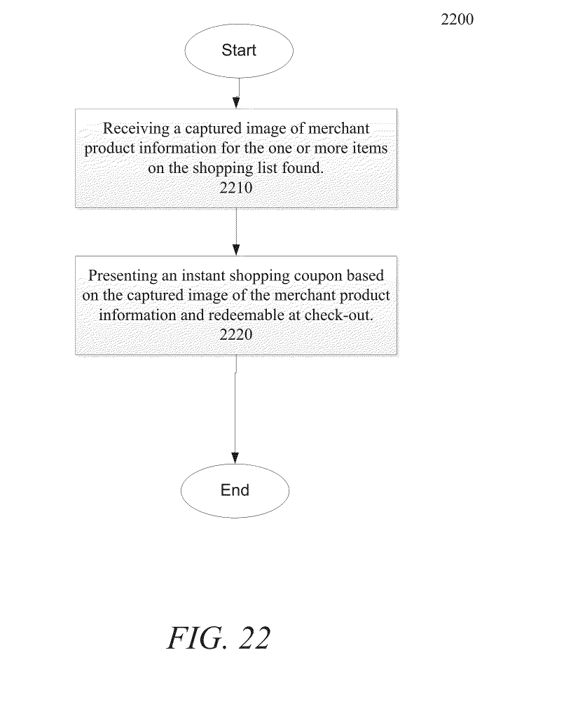

FIG. 22 is a processing flow chart illustrating an example embodiment of a method for providing a user with instant shopping coupons when merchant product information is scanned or photographed. In the example embodiment, the method 2200 includes receiving a captured image of a merchant product information on the shopping items found at 2210; and presenting an instant shopping coupon based on the captured image of the merchant product information and redeemable at check out at 2220.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connects the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., APIs).

### Example Machine Architecture and Machine-Readable Medium

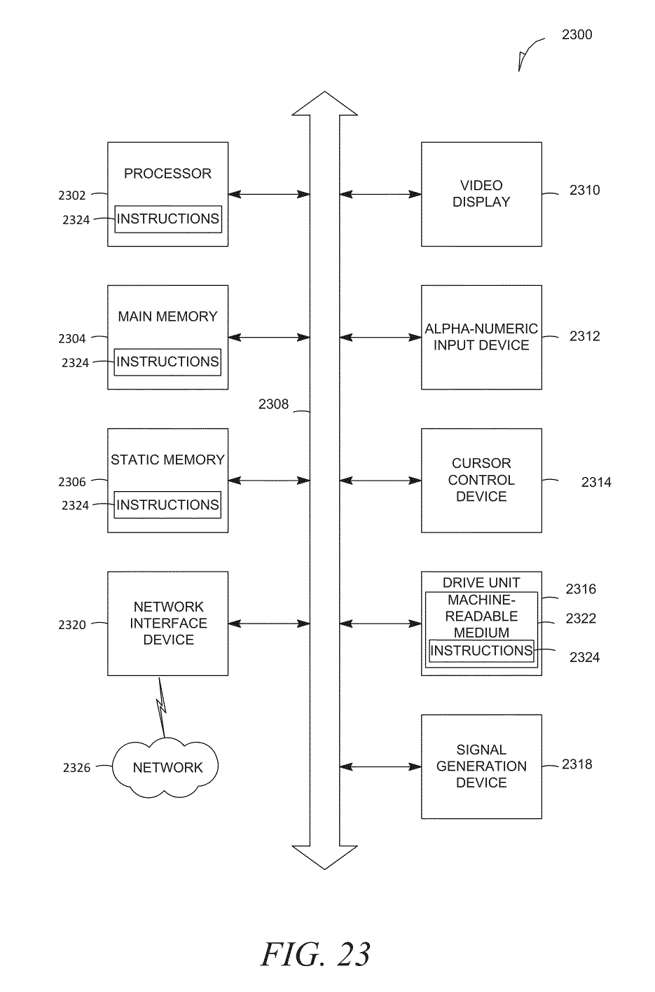

FIG. 23 shows a diagrammatic representation of machine in the example form of a computer system 2300 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 2300 includes a processor 2302 (e.g., a central processing unit (CPU) a graphics processing unit (GPU) or both), a main memory 2304 and a static memory 2306, which communicate with each other via a bus 2308. The computer system 2300 may further include a video display unit 2310 (e.g., a liquid crystal display (LCD) or a cathode ray tube (CRT)). The computer system 2300 also includes an alphanumeric input device 2312 (e.g., a keyboard), a cursor control device 2314 (e.g., a mouse), a disk drive unit 2316, a signal generation device 2318 (e.g., a speaker) and a network interface device 2320.

The disk drive unit 2316 includes a machine-readable medium 2322 on which is stored one or more sets of instructions (e.g., software 2324) embodying any one or more of the methodologies or functions described herein. The software 2324 may also reside, completely or at least partially, within the main memory 2304, the static memory 2306 and/or within the processor 2302 during execution thereof by the computer system 2300, the main memory 2304 and the processor 2302 also constituting machine-readable media.

For various embodiments, the set of instructions for software 2324 may include one or more functional modules shown in FIG. 4 in the shopping game system 400, and may include the shopping game application software 121, 131, 141 and the various aspects of the marketplace applications 220, including personalization applications, merchandizing applications, check-in location applications and imaging applications. The software 2324 may further be transmitted or received over a network 2326 via the network interface device 2320.

While the machine-readable medium 2322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Thus, a method and system to find in-store products using an interactive shopping game have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising
receiving a shopping list with one or more items;
receiving input from a user to personalize an interactive shopping game for a first user to play on a first portable electronic device;
generating the interactive shopping game based on the shopping list and the personalized user input; and
presenting information in the interactive shopping game to guide the first user to find the one or more items on the shopping list.

2. The method of claim 1, further comprising receiving the input from the user indicating that the one or more items on the shopping list is found.

3. The method of claim 2, further comprising presenting a reward acknowledgement to the first user as items on the shopping list are found.

4. The method of claim 1, further comprising:
receiving a captured image of merchant product information for the one or more items on the shopping list found; and
presenting an instant shopping coupon based on the captured image of the merchant product information and redeemable at check out.

5. The method of claim 1, wherein the receiving the shopping list with one or more items further comprises:
associating the first portable device with a second portable device; and
receiving the shopping list from the second portable device.

6. The method of claim 5, further comprising establishing the first portable device has a child user and the second portable device has a parent user, wherein the first user is the child user.

7. The method of claim 1, wherein the receiving the input from the user to personalize the interactive shopping game includes receiving at least one of the following information types: age, gender, mood, and interests.

8. The method of claim 1, further comprising:
receiving location information of the first portable electronic device within an in-store shopping environment; and
presenting additional features of the interactive shopping game associated with the location information of the first portable electronic device.

9. The method of claim 1, wherein the presenting information in the interactive shopping game to guide the first user to find the one or more items on the shopping list further comprises one or more tasks having representations of the products included on the shopping list.

10. A system, comprising:
a processor;
a network interface, coupled to the processor, to communicate with a server in a networked system; and
a memory including instructions that, when executed by the processor, cause the system to:
receive a shopping list with one or more items;
receive input from a user to personalize an interactive shopping game for a first user to play on a first portable electronic device;
generate the interactive shopping game based on the shopping list and the personalized user input; and
present information in the interactive shopping game to guide the first user to find the one or more items on the shopping list.

11. The system of claim 10, further including instructions that cause the system to receive input from the user indicating that the one or more items on the shopping list is found.

12. The system of claim 11, further including instructions that cause the system to present a reward acknowledgement to the first user as items on the shopping list are found.

13. The system of claim 10, further including instructions that cause the system to:
receive a captured image of merchant product information for the one or more items on the shopping list found; and
present an instant shopping coupon based on the captured image of the merchant product information and redeemable at check out.

14. The system of claim 10, wherein the instructions that cause the system to receive the shopping list with one or more items further includes instructions to cause the system to:
associate the first portable device with a second portable device; and
receive the shopping list from the second portable device.

15. The system of claim 14, further including instructions that cause the system to establish the first portable device has a child user and the second portable device has a parent user, wherein the first user is the child user.

16. The system of claim 10, wherein the instructions that cause the system to receive input from the user to personalize the interactive shopping game further includes instructions to cause the system to receive at least one of the following information types: age, gender, mood, and interests.

17. The system of claim 10, further including instructions that cause the system to:
receive location information of the first portable electronic device within an in-store shopping environment; and
present additional features of the interactive shopping game associated with the location information of the first portable electronic device.

18. The system of claim 10, wherein the instruction that cause the system to present information in the interactive shopping game to guide the first user to find the one or more items on the shopping list further includes instructions to provide one or more tasks having representations of the products included in the shopping list.

19. A machine-readable storage medium including instructions that, when executed on a system, cause the system to:
receive a shopping list with one or more items;
receive input from a user to personalize an interactive shopping game for a first user to play on a first portable electronic device;
generate the interactive shopping game based on the shopping list and the personalized user input; and
present information in the interactive shopping game to guide the first user to find the one or more items on the shopping list.

20. The machine-readable storage medium of claim 19, further including instructions that cause the system to receive the input from the user indicating that the one or more items on the shopping list is found.

21. The machine-readable storage medium of claim 20, further including instructions that cause the system to present a reward acknowledgement to the first user as items on the shopping list are found.

22. The machine-readable storage medium of claim 19, further including instructions that cause the system to:
receive a captured image of merchant product information for the one or more items on the shopping list found; and
present an instant shopping coupon based on the captured image of the merchant product information and redeemable at check out.

23. The machine-readable storage medium of claim 19, wherein the instruction that cause the system to receive the shopping list with one or more items include instructions to:
associate the first portable device with a second portable device; and
receive the shopping list from the second portable device.

24. The machine-readable storage medium of claim 23, further including instructions that cause the system to establish the first portable device has a child user and the second portable device has a parent user, wherein the first user is the child user.

25. The machine-readable storage medium of claim 19, wherein the instruction that cause the system to receive the input from the user to personalize the interactive shopping game further include instructions to receive at least one of the following information types: age, gender, mood, and interests.

26. The machine-readable storage medium of claim 19, further including instructions that cause the system to:
receive location information of the first portable electronic device within an in-store shopping environment; and
present additional features of the interactive shopping game associated with the location information of the first portable electronic device.

27. The machine-readable storage medium of claim 19, wherein the instruction that cause the system to present information in the interactive shopping game to guide the first user to find the one or more items on the shopping list further include one or more tasks having representations of the products included on the shopping list.
